(19) United States
(12) Patent Application Publication
(10) Pub. No.: US 2021/0224755 A1
(43) Pub. Date: Jul. 22, 2021

(54) DECISION METHOD OF CONDITION-BASED MAINTENANCE TO POWER GRID RISK

(71) Applicants: STATE GRID ZHEJIANG ELECTRIC POWER CORPORATION ECONOMIC AND TECHNOLOGICAL RESEARCH INSTITUTE, Zhejiang (CN); ZHEJIANG UNIVERSITY, Zhejiang (CN); STATE GRID ZHEJIANG ELECTRIC POWER CORPORATION NINGBO POWER SUPPLY COMPANY, Zhejiang (CN); NINGBO ELECTRIC POWER DESIGN INSTITUTE, Zhejiang (CN)

(72) Inventors: Hao FENG, Zhejiang (CN); Nanping MAO, Zhejiang (CN); Lijun YU, Zhejiang (CN); Xiaofen LU, Zhejiang (CN); Yongchang LAO, Zhejiang (CN); Furong PAN, Zhejiang (CN); Haojun YAN, Zhejiang (CN); Zhengchuan SU, Zhejiang (CN); Ye YUAN, Zhejiang (CN); Huifang WANG, Zhejiang (CN)

(21) Appl. No.: 16/306,023

(22) PCT Filed: Oct. 26, 2018
(86) PCT No.: PCT/CN2018/112130

§ 371 Date: Nov. 30, 2018

(30) Foreign Application Priority Data
Oct. 27, 2017 (CN) 201711021537.6

(51) Int. Cl. G06Q 10/00; G06N 7/00; G06Q 10/06; H02J 3/00

(52) U.S. Cl. CPC G06Q 10/20; G06N 7/005; H02J 3/001; G06Q 10/06316; G06Q 10/06312; G06Q 10/0635

(57) ABSTRACT

Disclosed is a decision method of condition-based maintenance to a power grid risk. The method includes: calculating a contribution of each device to be maintained of a plurality of devices to be maintained to the power grid risk in a current operation mode of a power grid, and determining the contribution of the each device to be maintained to the power grid risk as a set value corresponding to the each device to be maintained; determining a maintenance decision order of the devices to be maintained according to a descending order of set values corresponding to the devices to be maintained; and sequentially making maintenance decisions on the devices to be maintained according to the determined maintenance decision order. In the disclosure, a contribution of each device to be maintained to a power grid risk in a current operation mode of a power grid is determined; a decision order of the devices to be maintained is determined by arranging the contribution in descending order; and a maintenance period is sequentially determined based on a minimum cumulative risk according to the decision order of the device to be maintained. Thus the maintenance safety is improved.

This application claims priority to a Chinese patent application No. 201711021537.6 filed on Oct. 27, 2017, disclosure of which is incorporated herein by reference in its entirety.

### TECHNICAL FIELD

The disclosure belongs to the technical field of power systems. For example, the disclosure relates to a decision method of condition-based maintenance (CBM) to a power grid risk.

### BACKGROUND

The condition-based maintenance is a maintenance mode in which a change trend of a condition parameter of a device is monitored, the degradation condition of the device is determined, and maintenance is performed in case of obvious degradation. Scientific condition-based maintenance can not only extend the economic life of the device, but also ensure a safe and reliable operation of the power grid and improve the effectiveness and economy of the maintenance. When a maintenance plan is formulated, a condition evaluation result is used as a criterion to determine whether a device is to be maintained, as well as the maintenance mode of the device, such as overall maintenance, partial maintenance and general maintenance. How to scientifically and reasonably arrange the maintenance period is a research hotspot, that is, the device to be maintained is arranged in a reasonable maintenance period according to the decision of condition-based maintenance of a power grid. Therefore, the decision of condition-based maintenance is the optimization of the maintenance plan based on the current state evaluation result of the device, including the determination of the maintenance mode and the maintenance period. In the related art, the research of the decision of condition-based maintenance to the power grid is mainly divided into two categories. For the first category where the number of candidate maintenance solutions is limited, each solution is evaluated by using different decision-making methods, and the priorities of the solutions are determined or an optimal solution is selected. This research method only applies when a limited number of maintenance solutions are provided for the maintenance decision on the device-level. For the second category, a target model is established, and a decision algorithm is adopted to make a decision on the maintenance period or maintenance order of the device when some constraints are considered. This research method tends to blindly pursue the minimum total operation risk during the entire maintenance cycle of the power system. The operation risks may vary greatly between different time periods. For example, the operation risk may be low in some time periods, while the system operation risk may be too high in other maintenance periods. Once the high-risk event becomes reality, huge losses will be brought.

### SUMMARY

The disclosure provides a decision method of condition-based maintenance to a power grid risk based on a minimum cumulative risk to improve maintenance safety.

A decision method of condition-based maintenance to a power grid risk is provided and includes: calculating a contribution of each device to be maintained to the power grid risk in a current operation mode of a power grid, and determining the contribution of the each device to be maintained to the power grid risk as a set value corresponding to the each device to be maintained; determining a maintenance decision order of the devices to be maintained according to a descending order of set values corresponding to devices to be maintained; and sequentially making maintenance decisions on the devices to be maintained according to the determined maintenance decision order.

In an embodiment, for each device to be maintained i, the decision method includes: obtaining candidate maintenance intervals, calculating cumulative risk values in the respective candidate maintenance intervals, selecting the each device to be maintained i one of the candidate maintenance intervals with a smallest cumulative risk value, and entering an examination step; determining whether a time period exists during which a number of devices maintained exceeds an allowed number of devices to be maintained at the same time in the power grid; if the time period exists, deleting the arranged candidate maintenance interval, reselecting for the each device to be maintained i in one of remaining candidate maintenance intervals with a second smallest cumulative risk value, and repeating the examination step; and if the time period does not exists, finishing a decision on the each device to be maintained i.

In an embodiment, a contribution dᵢ of each device to be maintained i to the power grid risk is calculated via a formula

$${d}_{i} = {\sum }_{k ∈ {D}_{i}} {ϕ}_{ki} ,$$

where Dᵢ is a fault condition set including faults of the each device to be maintained i, φₖᵢ is a contribution of the each device to be maintained i to an operation risk in a fault condition k and is calculated via a formula:

φₖᵢ=RF_{Xi}*RF(X1,X2, . . . Xh)/(RF_{X1}+RF_{X2}+ . . . RF_{Xh})

where RF_{Xi} is a power grid risk caused by the fault of the each device to be maintained i and is represented by a product of a fault rate of the each device to be maintained i and a loss-of-load quantity of the power grid caused by the fault of the each device to be maintained i; RF(X1, X2, . . . Xh) is a total power grid risk in the fault condition k and is represented by a product of a probability of occurrence of the fault condition k and a loss-of-load quantity of the power grid in the fault condition k; and for each fault condition k∈Dᵢ, h is a number of faulty devices in the fault condition k of the power grid, and (RF_{X1}+RF_{X2}+ . . . RF_{Xh}) is a sum of power grid risk values of the faulty devices in the fault condition k of the power grid.

In an embodiment, the loss-of-load quantity of the power grid in the fault condition k is calculated by a direct current optimal power flow model.

In an embodiment, in each candidate maintenance interval, the cumulative risk value of the each device to be maintained i is obtained by accumulating a power grid risk R(Tₘ) of all time periods in the each candidate maintenance interval, and the power grid risk R(Tₘ) is calculated via a formula R(Tₘ)=RM(Tₘ)+RF(Tₘ), where RM(Tₘ) is a maintenance risk of the power grid in a period Tₘ and is represented by a loss-of-load quantity caused by maintenance of the power grid; RF(Tₘ) is a fault risk of the power grid in the period Tₘ and thus a combination of a probability of occurrence of a fault and a loss-of-load quantity caused by the fault, and is calculated via a formula

$$R F ( {T}_{m} ) = {\sum }_{D ( {T}_{m} )} {P}_{k} ( {T}_{m} ) {E}_{k} ( {T}_{m} ) , k ∈ D ( {T}_{m} ) ,$$

where D(Tₘ) is a fault condition set in consideration of maintenance in the period Tₘ; Eₖ(T^{m}) is an unplanned loss-of-load quantity caused by a fault condition k in a maintenance period Tₘ, and Pₖ (Tₘ) is a probability of occurrence of the fault condition k of the power grid in consideration of maintenance in the period Tₘ; and the probability of occurrence of the fault condition k in the period Tₘ is calculated via a formula

$${P}_{k} ( {T}_{m} ) = {\prod }_{i = 1}^{{N}_{F}} {λ}_{i} ( {T}_{m} ) {\prod }_{j = 1}^{{N}_{Q} - {N}_{F}} ( 1 - {λ}_{j} ( {T}_{m} ) ) ,$$

where N_{F} is a number of out-of-service devices to be maintained in the fault condition k, N_{Q}−N_{F} is a number of in-service devices to be maintained in the fault condition k, and λᵢ(Tₘ) is a fault rate of the each device to be maintained i in the period Tₘ.

In an embodiment, the fault rate of the each device to be maintained i is represented by a formula λᵢ(Tₘ)=Kᵢ*e^{-C}^{ᵢ}^{gHI}^{ᵢ}^{(T}^{ₘ}⁾; after the decision on the each device to be maintained i is finished, if Tₘ≤Sᵢ, a health index of the each device to be maintained i in the period Tₘ is HIᵢ(T)=Hᵢ₀; if Tₘ≥Sᵢ+bᵢ, the health index is HIᵢ(Tₘ)=βᵢHIᵢ₀, where HIᵢ₀ is an initial value of the health index of the each device to be maintained i, βᵢ is a health repair factor after maintenance of the each device to be maintained, Kᵢ is a scale parameter Kᵢ of a fault rate model of the each device to be maintained, Cᵢ is a curvature parameter of the fault rate model of the each device to be maintained, Sᵢ is a starting time period of the maintenance of the each device to be maintained i, and bᵢ is a number of time periods for the maintenance of the each device to be maintained i.

In an embodiment, before the step of calculating a contribution of each device to be maintained to a power grid risk under a current operation mode of a power grid, and determining the contribution of the each device to be maintained to the power grid risk as a set value corresponding to a device to be maintained, the method further includes a step of obtaining a calculation parameter, where the calculation parameter includes at least one of: the each device to be maintained i, a maintenance mode of the each device to be maintained i, an allowed number MA of devices to be maintained at the same time in the power grid in each time period, a number bᵢ of time periods for maintenance of the each device to be maintained i, an initial value HIᵢ₀ of the health index of the each device to be maintained i, a health repair factor βᵢ, after the maintenance of the each device to be maintained i, a scale parameter Kᵢ and a curvature parameter Cᵢ of a fault rate model of the each device to be maintained i, a structure parameter of the power grid, and a predicted load value of a power grid node in a maintenance cycle.

A storage medium stores computer-executable instructions for executing any decision method of condition-based maintenance to a power grid risk described above.

### BRIEF DESCRIPTION OF DRAWINGS

The drawing referred in the description of the embodiments will be described below.

FIG. 1 is a flowchart of a decision method of condition-based maintenance to a power grid risk based on a minimum cumulative risk according to an embodiment.

### DETAILED DESCRIPTION

The disclosure will be described below in conjunction with the embodiments.

A power grid risk includes a maintenance risk and a fault risk. The maintenance risk reflects a risk caused by maintenance, and the fault risk reflects a risk caused by a fault of a device due to inadequate maintenance of the power grid.

An ideal maintenance model for the power grid risk may be expressed as: R(Tₘ)=R(Tₙ) m, n ∈{1, 2, . . . , M} and m≠n, where M is the number of time periods in a maintenance cycle; m [symbol] n are any two different time periods in the maintenance cycle; and R(Tₘ) [symbol] R(Tₘ) are the respective operation risks of the power grid in the mth maintenance period and the nth maintenance period. In fact, it is difficult to have completely same operation risk in all time periods of the maintenance cycle. Therefore, the embodiment proposes an objective function with the smallest standard deviation of the power grid risk for all time period in the maintenance cycle, and the formula is

$$min f = \sqrt{\frac{1}{M} * {\sum }_{m = 1}^{M} {( R ( {T}_{m} ) - \frac{1}{M} {\sum }_{n = 1}^{M} R ( {T}_{n} ) )}^{2}} ,$$

where min f is a minimum function.

The standard deviation of a risk may measure the degree of fluctuation of the risk during all time periods. The smaller the standard deviation is, the smaller the fluctuation of the risk during every time period is. The maintenance decision is made by considering that a total risk is small and also that the standard deviation of the power grid risk during every time period of the maintenance cycle is minimum.

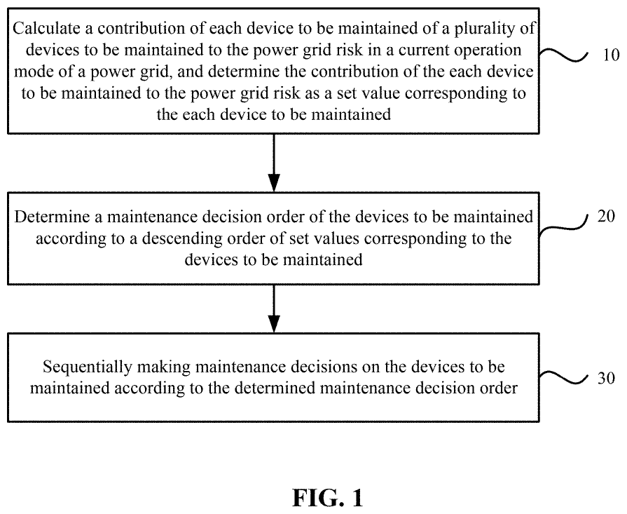

As shown in FIG. 1, a decision method of condition-based maintenance to a power grid risk based on the minimum cumulative risk provided by an embodiment includes the steps described below.

In a step 10, a contribution of each device to be maintained to a power grid risk in a current operation mode of a power grid is calculated, and the contribution of the each device to be maintained to the power grid risk is determined as a set value corresponding to the each device to be maintained.

In a step 20, a maintenance decision order of devices to be maintained is determined according to a descending order of set values of the devices to be maintained.

In a step 30, maintenance decisions on the devices to be maintained are made sequentially according to the determined maintenance decision order.

In the embodiment, the time period refers to a unit time period; the maintenance interval refers to a time interval required for maintenance of the device to be maintained and includes multiple consecutive time periods; and the cumulative risk value of the device to be maintained refers to the sum of the power grid risks of the device to be maintained in all time periods of the maintenance interval. If other constraints are not considered, when the sum of the power grid risks of the device to be maintained in all the time periods of a maintenance interval is the smallest, this maintenance interval is the optimal maintenance interval of the device.

In the embodiment, the contribution of each of devices to be maintained to the power grid risk is calculated and is used as a criterion for determining the maintenance decision order of the devices, and the maintenance decisions on the devices to be maintained are sequentially made according to the maintenance decision order for reducing the standard deviation of the power grid risk in all time periods of the maintenance cycle. The basic principle of the reduction of the standard deviation of the power grid risk in all time periods of the maintenance cycle by using the decision method of condition-based maintenance to the power grid risk provided in the embodiment is described below. In the decision of devices to be maintained, the maximum number of devices to be maintained in the same time period is limited, so when the number of devices maintained in a same time period reaches the maximum limit, no other devices can be maintained in this time period. If a device with a large contribution to the power grid risk is provided with a priority in the decision, the probability that the device to be maintained with a large contribution to the power grid risk is limited by the maximum number of devices is relatively low, that is, the probability that the device to be maintained with a large contribution to the power grid risk is arranged in the optimal maintenance interval is high. Since the device to be maintained with a large contribution to the power grid risk contributes a lot to the power grid risk, the cumulative risk value of the device to be maintained is relatively large in each maintenance interval. When the device to be maintained is arranged in the optimal maintenance interval, the cumulative risk value of the device to be maintained in each maintenance interval and the cumulative risk values of other devices are relatively closer, that is, the standard deviation of the power grid risk in all time periods of the maintenance cycle is smaller. If one of the multiple devices to be maintained cannot be arranged in the optimal maintenance interval due to the limit of the maximum number of devices and if a device to be maintained with a small contribution to the power grid risk is selected and arranged in a non-optimal maintenance interval, the standard deviation of the power grid risk in all time periods of the maintenance cycle is more likely to be smaller than in other cases.

In the step 10, a risk tracking method may be used for calculating the contribution of the device to be maintained to the power grid risk. For example, for any determined fault condition in a fault condition set, a contribution of each faulty device in this fault condition to a power grid operation risk is tracked, and then risk values in all fault conditions of the fault condition set are comprehensively combined and assigned to the devices to be maintained according to the contribution. For example, in the case of considering all possible fault conditions of the power grid, the contribution of each device to be maintained to the power grid risk is represented by {dᵢ}, including d₁, d₂, d₃, . . . dᵢ . . . dₓ. d₁ represents the contribution of the device to be maintained 1 to the power grid risk, that is, the set value of the device to be maintained 1. d₂ represents the contribution of the device to be maintained 2 to the power grid risk, that is, the set value of the device to be maintained 2. d₃ represents the contribution of the device to be maintained 3 to the power grid risk, that is, the set value of the device to be maintained 3. dₓ represents the contribution of the device to be maintained x to the power grid risk, that is, the set value of the device to be maintained x. The value of the x is the total number of devices to be maintained; and dᵢ may be any one from d₁ to dₓ. In the case of considering all possible fault conditions of the power grid, a contribution dᵢ of a single device to be maintained dᵢ to the power grid risk is calculated via a formula

$${d}_{i} = {\sum }_{k ∈ {D}_{i}} {ϕ}_{ki} ,$$

Dᵢ is a fault condition set including faults of the device to be maintained i, φₖᵢ is a contribution of the device to be maintained i to a power grid operation risk in a fault condition k, and is calculated via a formula:

φₖᵢ=RF_{Xi}*RF(X1,X2, . . . Xh)/(RF_{X1}+RF_{X2}+ . . . RF_{Xh})

where RF_{Xi} is a power grid risk caused only by a fault of the device to be maintained i and is represented by a product of a fault rate of the device to be maintained i and a loss-of-load quantity of the power grid caused by the fault of the device to be maintained i. RF(X1,X2, . . . Xh) is a total power grid risk in the fault condition k and is represented by a product of a probability of occurrence of the fault condition k and a loss-of-load quantity of the power grid in the fault condition k. For any fault condition k∈Dᵢ, h is the number of faulty devices in the fault condition k of the power grid, and (RF_{X1}+RF_{X2}+ . . . X_{Xh}) is the sum of power grid risk values of the faulty devices in the fault condition k of the power grid. Here, a description is given of the fault condition set including faults of the device to be maintained i. If a fault causing a fault condition includes a fault of the device to be maintained i, the fault condition belongs to a fault condition set including the fault of the device to be maintained i. For example, the fault condition k is cause by a fault of the device to be maintained 1; a fault condition x is caused by the fault of the device to be maintained 1 and a fault of the device to be maintained 2; a fault condition y is caused by the fault of the device to be maintained 1, the fault of the device to be maintained 2 and a fault of the device to be maintained 3. Therefore, the fault condition set including the fault of the device to be maintained 1 includes the fault condition k, the fault condition x, and the fault condition y.

In the step 20, for example, after {dᵢ} is arranged in the descending order, the serial numbers of the devices are returned to form a sequence {H(j)} of the devices to be maintained. {H(j)} includes H(1), H(2), H(3) . . . , H(j) . . . . The decision is sequentially made according to {H(j)} and the decisions on the devices to be maintained may be sequentially made in the order that j gradually increases from 1, that is, the decisions are sequentially made in the order of the device sequence H(1), H(2), H(3), . . . . The {H(j)} is assumed to be arranged in the descending order as d₃, d₁, d₂, . . . dₓ, then the device sequence corresponding to d₃ is H(1), that is, the decision order of the device to be maintained 3 is first; the device sequence corresponding to d₁ is H(2), that is, the decision order of the device to be maintained 1 is second; and the device sequence corresponding to d₂ is H(3) that is, the decision order of the device to be maintained 2 is third, and so on.

In the step 30, maintenance decisions on multiple devices to be maintained are made according to the order of maintenance decisions, and the decision process is performed as below. When the first device to be maintained is arranged, j=1, and a decision step of a single device is entered as described below. A decision is made on a device to be maintained with a sequence number of H(j) according to the decision method of a single device to be maintained. After the decision is made, whether the device to be maintained is the last one is determined. If not, j=j+1, and the decision step of the single device is repeated. If yes, the decisions on all devices to be maintained have been made, and all steps are ended. A decision method for a single device to be maintained i is: obtaining a plurality of candidate maintenance intervals, calculating cumulative risk values in the respective candidate maintenance interval, selecting for the device to be maintained i one candidate maintenance interval with a smallest cumulative risk value, and entering an examination step; in the examination step, determining whether a time period exists during which the number of devices maintained exceeds the allowed number of devices to be maintained at the same time in the power grid; if yes, deleting the arranged candidate maintenance interval, reelecting for the device to be maintained i one of the remaining candidate maintenance intervals with a second smallest cumulative risk value, and repeating the examination step; and if not, finishing a decision on the device to be maintained i.

Here, any continuous interval lasting for bᵢ time periods in the maintenance cycle is the candidate maintenance interval of the device, and bᵢ is the number of time periods required for the maintenance of the device i. The number of time periods required for maintenance of each device is known. The time period as a unit time may be set according to actual situations, such as 1 hour, 1 day or 1 week, and is generally set to 1 day. The cumulative risk value of the device to be maintained i in the candidate maintenance interval is the sum of the power grid risks in all time period of the candidate maintenance interval.

In the candidate maintenance interval, the cumulative risk value of the device to be maintained i is obtained by accumulating a power grid risk R(Tₘ) of all time periods in the candidate maintenance interval, and the power grid risk R(Tₘ) in a period Tₘ may be calculated via a formula R(Tₘ)=RM(Tₘ)+RF(Tₘ) where RM(Tₘ) is a maintenance risk of the power grid in the period Tₘ and is represented by a loss-of-load quantity caused by maintenance of the power grid; RF(Tₘ) is a fault risk of the power grid in the period Tₘ and thus is a combination of a probability of occurrence of a fault and a loss-of-load quantity caused by the fault. Therefore, it is obtained that

$$R F ( {T}_{m} ) = {\sum }_{D ( {T}_{m} )} {P}_{k} ( {T}_{m} ) {E}_{k} ( {T}_{m} ) , k ∈ D ( {T}_{m} ) ,$$

where D(Tₘ) is a fault condition set in consideration of maintenance in the period Tₘ, and the consideration of maintenance means that: another device to be maintained may be arranged for maintenance in the period Tₘ, and D(Tₘ) is the fault condition set in consideration of the device that has been arranged for maintenance considered. Eₖ (Tₘ) is an unplanned loss-of-load quantity caused by a fault condition k in a maintenance period Tₘ. Pₖ(Tₘ) is a probability of occurrence of the fault condition k of the power grid in consideration of maintenance in the period Tₘ. The fault condition is a fault caused by a single device to be maintained or by two or more devices to be maintained. According to a condition enumeration method, the probability of occurrence of the fault condition k in the period Tₘ is calculated via

$${P}_{k} ( {T}_{m} ) = {\prod }_{i = 1}^{{N}_{F}} {λ}_{i} ( {T}_{m} ) {\prod }_{j = 1}^{{N}_{Q} - {N}_{F}} ( 1 - {λ}_{j} ( {T}_{m} ) ) ,$$

where N_{F} is the number of out-of-service devices to be maintained that are in the fault condition k, N_{Q}−N_{F} is the number of in-service devices to be maintained in the fault condition k, λᵢ(Tₘ) is a fault rate of the device to be maintained i in the period Tₘ and the model is λᵢ(Tₘ)=K*e^{-C}^{ᵢ}^{gHI}^{ᵢ}^{(T}^{ₘ}⁾, where λⱼ(Tₘ) is a fault rate of the device to be maintained j in the period Tₘ.

In the related art, an existing fault rate model of the power grid is λᵢ(Tₘ)=Kᵢ*e^{-C}^{ᵢ}^{gHI}^{ᵢ}^{(T}^{ₘ}⁾, where Hᵢ(Tₘ) is a health index of the device to be maintained i, Kᵢ is a scale parameter of a fault rate model of the device to be maintained i, and Cᵢ is a curvature parameter of the fault rate model of the device to be maintained i. Since the device to be maintained i has different values of the health index before and after the maintenance, a health repair factor βᵢ after the maintenance of the device to be maintained i is introduced in the embodiment. Therefore, before the maintenance of the device to be maintained i, that is Tₘ≤Sᵢ, the health index of the device to be maintained i in the period Tₘ is HIᵢ(Tₘ)=HIᵢ₀; where HIᵢ₀ is an initial value of the health index of the device to be maintained i; and after the maintenance, that is, Tₘ≥Sᵢ+bᵢ, the health is HIᵢ(Tₘ)=βᵢHIᵢ₀. βᵢ may be obtained according to the type of the maintenance and may has a value of 1.5, 1.3 and 1.2 respectively in three types of power outage maintenance modes: overall maintenance, partial maintenance and general maintenance.

Since the actual power grid operation generally meets the N−1 test, the fault condition set of the device to be maintained is enumerated to the second-order fault, which can cover faults with a high power grid risk, and eliminate high-order faults with a small probability of occurrence. Thus, a balance between reasonability and calculating speed is achieved.

To obtain the required parameter, a step of obtaining a calculation parameter may be included before the step 10. The calculation parameter to be obtained includes one or more of: a device to be maintained i, a maintenance mode of the device to be maintained i, the allowed number of devices MA to be maintained in each time period in the power grid, the number bᵢ of time periods for maintenance of the device to be maintained i, an initial value HIᵢ₀ of the health index of the device to be maintained i, a health repair factor βᵢ after maintenance of the device to be maintained i, a scale parameter Kᵢ and a curvature parameter Cᵢ of a fault rate model of the device to be maintained i, a structure parameter of the power grid, and a predicted value of a node load of the power grid in a maintenance cycle. The structure parameter of the power grid and the predicted load value of the power grid node in the maintenance cycle are parameters required for the direct current optimal power flow model to calculate the loss-of-load quantity in a certain operation condition of the power grid.

1. A decision method of condition-based maintenance to a power grid risk, comprising:
calculating a contribution of each device to be maintained of a plurality of devices to be maintained to the power grid risk in a current operation mode of a power grid, and determining the contribution of the each device to be maintained to the power grid risk as a set value corresponding to the each device to be maintained;
determining a maintenance decision order of the devices to be maintained according to a descending order of set values corresponding to the devices to be maintained; and
sequentially making maintenance decisions on the devices to be maintained according to the determined maintenance decision order.

2. The method of claim 1, wherein for each device to be maintained i, the decision method comprises:
obtaining a plurality of candidate maintenance intervals, calculating a plurality of cumulative risk values in the respective candidate maintenance intervals, selecting for the each device to be maintained i one of the candidate maintenance intervals with a smallest cumulative risk value, and entering an examination step;
determining whether a time period exists during which a number of devices maintained exceeds an allowed number of devices to be maintained at the same time in the power grid;
when the time period exists, deleting the arranged candidate maintenance interval, reselecting for the each device to be maintained i one of remaining candidate maintenance intervals with a second smallest cumulative risk value, and repeating the examination step; and
when the time period does not exists, finishing a decision on the each device to be maintained i.

3. The method of claim 1, wherein a contribution dᵢ of each device to be maintained i to the power grid risk is calculated via a formula
$${d}_{i} = {\sum }_{k ∈ {D}_{i}} {ϕ}_{ki} ,$$
wherein Dᵢ is a fault condition set comprising faults of the each device to be maintained i, φₖᵢ is a contribution of the each device to be maintained i to an operation risk in a fault condition k and is calculated via a formula:
φₖᵢ=RF_{Xi}*RF(X1,X2, . . . Xh)/(RF_{X1}+RF_{X2}+ . . . RF_{Xh})
wherein, RF_{Xi} is a power grid risk caused by the fault of the each device to be maintained i and is represented by a product of a fault rate of the each device to be maintained i and a loss-of-load quantity of the power grid caused by the fault of the each device to be maintained i; RF(X1, X2, . . . Xh) is a total power grid risk in the fault condition k and is represented by a product of a probability of occurrence of the fault condition k and a loss-of-load quantity of the power grid in the fault condition k; and for each fault condition k∈Dᵢ, h is a number of faulty devices in the fault condition k of the power grid, and (RF_{X1}+RF_{X2}+ . . . RF_{Xh}) is a sum of power grid risk values of the faulty devices in the fault condition k of the power grid.

4. The method of claim 3, wherein the load loss-of-load quantity of the power grid in the fault condition k is calculated by a direct current optimal power flow model.

5. The method of claim 2, wherein in each candidate maintenance interval of the candidate maintenance intervals, the cumulative risk value of each device to be maintained i is obtained by accumulating a power grid risk R(Tₘ) of all time periods in the each candidate maintenance interval, and the power grid risk R(Tₘ) is calculated via a formula R(Tₘ)=RM(Tₘ)+RF(Tₘ), wherein RM(Tₘ) is a maintenance risk of the power grid in a period Tₘ and is represented by a loss-of-load quantity caused by maintenance of the power grid; RF(Tₘ) is a fault risk of the power grid in the period Tₘ and thus a combination of a probability of occurrence of a fault and a loss-of-load quantity caused by the fault, and is calculated via a formula
$$R F ( {T}_{m} ) = {\sum }_{D ( {T}_{m} )} {P}_{k} ( {T}_{m} ) {E}_{k} ( {T}_{m} ) , k ∈ D ( {T}_{m} ) ,$$
wherein D(Tₘ) is a fault condition set in consideration of maintenance in the period Tₘ; Eₖ(Tₘ) is an unplanned loss-of-load quantity caused by a fault condition k in a maintenance period Tₘ, and Pₖ(Tₘ) is a probability of occurrence of the fault condition k of the power grid in consideration of maintenance in the period Tₘ; and the probability of occurrence of the fault condition k in the period Tₘ is calculated via a formula
$${P}_{k} ( {T}_{m} ) = {\prod }_{i = 1}^{{N}_{F}} {λ}_{i} ( {T}_{m} ) {\prod }_{j = 1}^{{N}_{Q} - {N}_{F}} ( 1 - {λ}_{j} ( {T}_{m} ) ) ,$$
wherein N_{F} is a number of out-of-service devices to be maintained in the fault condition k, N_{Q}−N_{F} is a number of in-service devices to be maintained in the fault condition k, and λᵢ(Tₘ) is a fault rate of the each device to be maintained i in the period Tₘ.

6. The method of claim 5, wherein the fault rate of the each device to be maintained i is represented by a formula λᵢ(Tₘ)=Kᵢ*e^{-C}^{ᵢ}^{gHI}^{ᵢ}^{(T}^{ₘ}⁾; after the decision on the each device to be maintained i is finished, in a case where Tₘ≤Sᵢ, a health index of the each device to be maintained i in the period Tₘ is HIᵢ (Tₘ)=HIᵢ₀ in a case where Tₘ≥Sᵢ+bᵢ, the health index is HIᵢ(Tₘ)=βᵢHIᵢ₀, wherein HIᵢ₀ is an initial value of the health index of the each device to be maintained i, βᵢ is a health repair factor after maintenance of the each device to be maintained i, Kᵢ is a scale parameter of a fault rate model of the each device to be maintained i, Cᵢ is a curvature parameter of the fault rate model of the each device to be maintained i, Sᵢ is a starting time period of the maintenance of the each device to be maintained i, and bᵢ is a number of time periods for the maintenance of the each device to be maintained i.

7. The method of claim 1, before the calculating a contribution of each device to be maintained to a power grid risk under a current operation mode of a power grid, and determining the contribution of the each device to be maintained to the power grid risk as a set value corresponding to a device to be maintained, the method further comprises:
obtaining a calculation parameter, wherein the calculation parameter comprises at least one parameter of a group consisting of: each device to be maintained i, a maintenance mode of the each device to be maintained i, an allowed number MA of devices to be maintained at the same time in the power grid in each time period, a number bᵢ of time periods for maintenance of the each device to be maintained i, an initial value HIᵢ₀ of a health index of the each device to be maintained i, a health repair factor βᵢ after the maintenance of the each device to be maintained i, a scale parameter Kᵢ and a curvature parameter Cᵢ of a fault rate model of the each device to be maintained i, a structure parameter of the power grid, and a predicted load value of a power grid node in a maintenance cycle.

8. A storage medium, which stores computer-executable instructions for executing decision method of condition-based maintenance to a power grid risk, where the method:
calculating a contribution of each device to be maintained of a plurality of devices to be maintained to the power grid risk in a current operation mode of a power grid, and determining the contribution of the each devise to be maintained to the power grid risk as a set value corresponding to the each devise to me maintained;
determining a maintenance decision order of the devices to be maintained according to a descending order of set values corresponding to the devises to be maintained; and
sequentially making maintenance decisions on the devices to be maintained according to the determined maintenance decision order.

9. The storage medium of claim 8, wherein for each device to be maintained i, the method comprises:
obtaining a plurality of candidate maintenance intervals, calculating a plurality of cumulative risk values in the respective candidate maintenance intervals, selecting for the each device to be maintained i one of the candidate maintenance intervals with a smallest cumulative risk value, and entering an examination step;
determining whether a time period exists during which a number of devices maintained exceeds an allowed number of devices to be maintained at the same time in the power grid;
when the time period exists, deleting the arranged candidate maintenance interval, reselecting for the each device to be maintained i one of remaining candidate maintenance intervals with a second smallest cumulative risk value, and repeating the examination step; and
when the time period does not exists, finishing a decision on the each device to be maintained i.

10. The storage medium of claim 8, wherein a contribution dᵢ of each device to be maintained i to the power grid risk is calculated via a formula
$${d}_{i} = {\sum }_{k ∈ {D}_{i}} {ϕ}_{ki} ,$$
wherein Dᵢ is a fault condition set comprising faults of the each device to be maintained i, φₖᵢ is a contribution of the each device to be maintained i to an operation risk in a fault condition k and is calculated via a formula:
φₖᵢ=RF_{Xi}*RF(X1,X2, . . . Xh)/(RF_{X1}+RF_{X2}+ . . . RF_{Xh})
wherein, RF_{Xi} is a power grid risk caused by the fault of the each device to be maintained a and is represented by a product of a fault rate of the each device to be maintained i and a loss-of-load quantity of the power grid caused by the fault of the each device to be maintained i; RF(X1, X2, . . . Xh) is a total power grid risk in the fault condition k and is represented by a product of a probability of occurrence of the fault condition k and a loss-of-load quantity of the power grid in the fault condition k; and for each fault condition k∈Dᵢ, h is a number of faulty devices in the fault condition k of the power grid, and (RF_{X1}+RF_{X2}+RF_{Xh}) is a sum of power grid risk values of the faulty devices in the fault condition k of the power grid.

11. The storage medium of claim 10, wherein the load loss-of-load quantity of the power grid in the fault condition k is calculated by a direct current optimal power flow model.

12. The storage medium of claim 9, wherein in each candidate maintenance interval of the candidate maintenance intervals, the cumulative risk value of each device to be maintained i is obtained by accumulating a power grid risk R(Tₘ) of all time periods in the each candidate maintenance interval, and the power grid risk R(Tₘ) is calculated via a formula R(Tₘ)=RM(Tₘ)+RF(Tₘ) wherein RM(Tₘ) is a maintenance risk of the power grid in a period Tₘ and is represented by a loss-of-load quantity caused by maintenance of the power grid; RF(Tₘ) is a fault risk of the power grid in the period Tₘ and thus a combination of a probability of occurrence of a fault and a loss-of-load quantity caused by the fault, and is calculated via a formula
$$R F ( {T}_{m} ) = {\sum }_{D ( {T}_{m} )} {P}_{k} ( {T}_{m} ) {E}_{k} ( {T}_{m} ) , k ∈ D ( {T}_{m} ) ,$$
wherein D(Tₘ) is a fault condition set in consideration of maintenance in the period Tₘ; Eₖ(Tₘ) is an unplanned loss-of-load quantity caused by a fault condition k in a maintenance period Tₘ, and Pₖ(Tₘ) is a probability of occurrence of the fault condition k of the power grid in consideration of maintenance in the period Tₘ; and the probability of occurrence of the fault condition k in the period Tₘ is calculated via a formula
$${P}_{k} ( {T}_{m} ) = {\prod }_{i = 1}^{{N}_{F}} {λ}_{i} ( {T}_{m} ) {\prod }_{j = 1}^{{N}_{Q} - {N}_{F}} ( 1 - {λ}_{j} ( {T}_{m} ) ) ,$$
wherein N_{F} is a number of out-of-service devices to be maintained in the fault condition k, N_{Q}−N_{F} is a number of in-service devices to be maintained in the fault condition k, and λᵢ(Tₘ) is a fault rate of the each device to be maintained i in the period Tₘ.

13. The storage medium of claim 12, wherein the fault rate of the each device to be maintained a is represented by a formula λᵢ(Tₘ)=Kᵢ*e^{-C}^{ᵢ}^{gHI}^{ᵢ}^{(T}^{ₘ}⁾; after the decision on the each device to be maintained i is finished, in a case where Tₘ≤Sᵢ, a health index of the each device to be maintained i in the period Tₘ is HIₘ (Tₘ)=HIᵢ₀ in a case where Tₘ≥Sᵢ+bᵢ, the health index is HIᵢ(Tₘ)=βᵢHIᵢ₀, wherein HIᵢ₀ is an initial value of the health index of the each device to be maintained i, βᵢ is a health repair factor after maintenance of the each device to be maintained i, Kᵢ is a scale parameter of a fault rate model of the each device to be maintained i, Cᵢ is a curvature parameter of the fault rate model of the each device to be maintained i, Sᵢ is a starting time period of the maintenance of the each device to be maintained i, and bᵢ is a number of time periods for the maintenance of the each device to be maintained i.

14. The storage medium of claim 8, before the calculating a contribution of each device to be maintained to a power grid risk under a current operation mode of a power grid, and determining the contribution of the each device to be maintained to the power grid risk as a set value corresponding to a device to be maintained, the method further comprises:
obtaining a calculation parameter, wherein the calculation parameter comprises at least one parameter of a group consisting of: each device to be maintained i, a maintenance mode of the each device to be maintained i, an allowed number MA of devices to be maintained at the same time in the power grid in each time period, a number bᵢ of time periods for maintenance of the each device to be maintained i, an initial value HIᵢ₀ of a health index of the each device to be maintained i, a health repair factor βᵢ after the maintenance of the each device to be maintained i, a scale parameter Kᵢ and a curvature parameter Cᵢ of a fault rate model of the each device to be maintained i, a structure parameter of the power grid, and a predicted load value of a power grid node in a maintenance cycle
